(19) United States
(12) Patent Application Publication
(10) Pub. No.: US 2008/0285763 A1
(43) Pub. Date: Nov. 20, 2008

(54) Common Signal Eliminator From a Stereo Source

(76) Inventors: Richard Cote, Beauport (CA); Simon Roy, Charlesbourg (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/588,987

(22) PCT Filed: Dec. 6, 2004
(86) PCT No.: PCT/CA04/02217

§ 371 Date: Aug. 10, 2006

(30) Foreign Application Priority Data
Feb. 10, 2004 (CA) 2,456,373

(51) Int. Cl. H04R 5/00

(52) U.S. Cl. 381/19

(57) ABSTRACT

To increase the stereophonic potential of an ordinary stereo source, a device (20) eliminates the common signals from a stereo source. The device is installed in relation to four loudspeakers, two primary (38, 40) and two secondary (42, 44), and it includes a stereo input (34, 36) and an electric circuit that links the two secondary loudspeakers. The primary loudspeakers reproduce unaltered stereo signals and the secondary loudspeakers reproduce altered signals where (by hand: when) the circuit has eliminated the common signals from the two channels of the primary stereo source. Since all “mono” components of the sound [by hand: same amplitude, same frequency] have been eliminated from the secondary outputs, we obtain a “purely stereo” source. An additional channel (45) can be added in order to reproduce the common components of the stereo source.

This invention is related to the domain of sound, in particular, that which deals with the handling of various stereo source signals.

### PRIOR ART

Existing devices are either “surround sound” decoders, or devices that control three channels or more wherein the rear channels are generally mono, in other words, identical. Among others, we observe the following patents:
CA 2308576 a post-amplification decoding device using a central channel. In the illustration, one of the channels feeds two rear loudspeakers that play the same signal, in other words, mono.
CA 2330960 a “surround sound” decoder using a front center and a rear center.
FR 2308267 a four channel device that isolates the determined frequency bands.
U.S. Pat. No. 5,497,425 a system that necessarily requires an amplifier and a central channel.
U.S. Pat. No. 5,742,691 a conversion system wherein the rear channels are mono.
U.S. Pat. No. 6,038,324 a “surround sound” system for cars wherein the rear channels are “mono.”
U.S. Pat. No. 6,590,983 a system that uses a pair of filters to attenuate the signals at human voice level.

### OBJECTIVES AND ADVANTAGES

It is a general objective of the invention to produce a three-dimensional sound effect from any stereo sound source.

It is a particular objective to provide a device that permits, from a primary source of stereo sound, conventional or encoded, to generate a second stereophonic source different from the first, in particular by eliminating the common signals of the primary stereo sound source in order to produce a purely stereophonic sound.

A more particular objective is that the device is connected to the left and right primary signals and that this device produces two new signals; these new signals are produced by the instantaneous difference in amplitude and frequency between the left and right primary signals respectively. The result for a listener is the perception of a new stereo modulation of the primary signals thus giving the impression of a third sound dimension.

Another objective is that the difference in frequency and amplitude is channeled by polarized capacitors that let a sound pass a section at a time, having an intensity proportional to the difference of the potential between the two primary signals.

### DRAWINGS

With respect to the drawings that illustrate an embodiment of the invention,

FIG. 1 is a perspective of a device in use.

FIG. 2 is a preferred circuit diagram.

FIG. 3 is a diagram of the circuit of a second embodiment of the invention.

FIG. 4 is an illustration of an example of the different signals.

### DETAILED DESCRIPTION OF THE DRAWINGS

In the description that follows and in the accompanying drawings, similar numbers refer to identical parts in the figures.

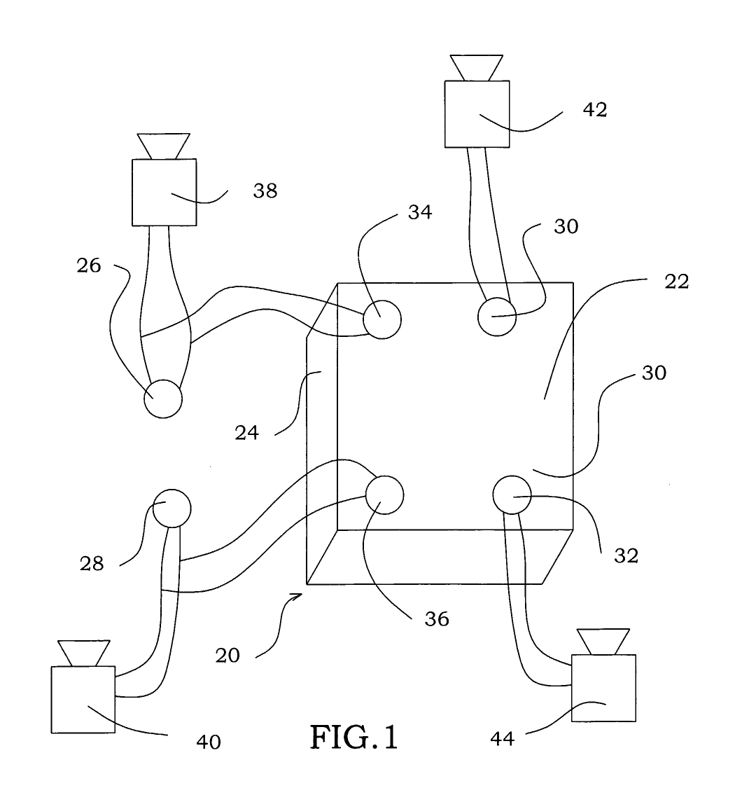

FIG. 1 illustrates a device 20 that includes a box with a top side 22 and a lateral side 24. On the top side, one observes four electrical contacts: input of the left primary stereo signal 34, input of the right primary stereo signal 36, left output of modified stereo signal 30 and the right output of modified stereo signal 32. The device is fed by a stereo signal source comprised of a left primary signal 26 and a right primary signal 28. Each of these primary signals constitutes a potential difference between one so-called positive terminal and a so-called negative terminal; they feed the whole system. The left primary signal feeds left primary loudspeaker 38 and the left input of device 34 at the same time. The right primary signal feeds right primary loudspeaker 40 and the right input of device 36 at the same time. An internal circuit that is not shown in FIG. 1 links the inputs of the devices to the outputs. Secondary loudspeakers left 42 and right 44 are linked to output terminals left 30 and right 32, respectively.

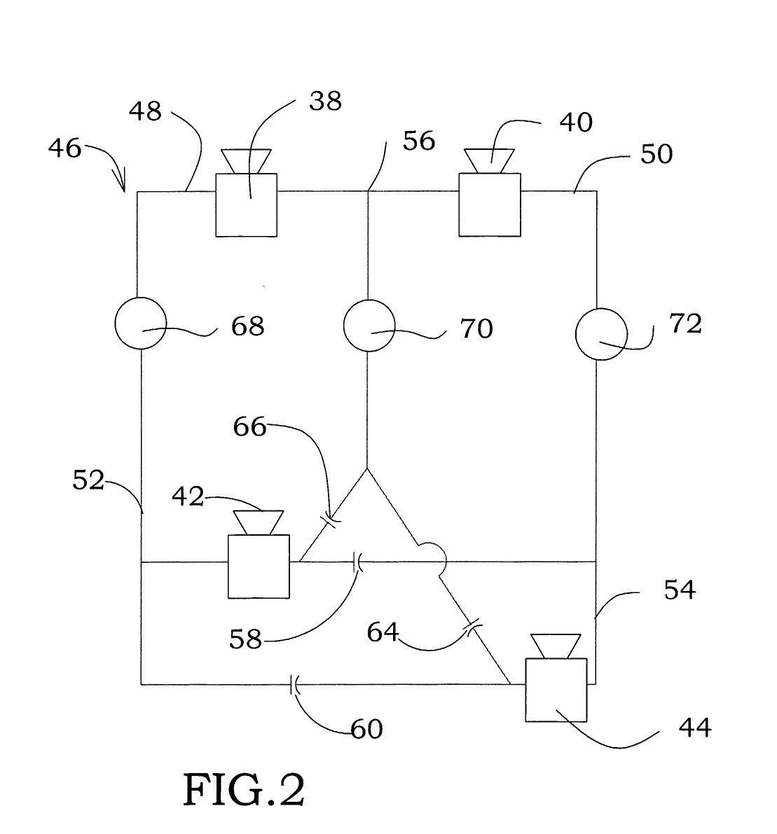

FIG. 2 illustrates preferred circuit 46 in a simplified form. In the preferred application, the four polarized capacitors (58, 60, 64, 66) are incorporated into the internal circuit of the box illustration in FIG. 1. Here, the negative terminals of the two primary signals are illustrated as a common negative terminal 70. We find schematically the potential differences associated with the left and right primary stereo signals among common ground 70 and terminals left 68 and right 72 respectively. We are witnessing that primary loudspeakers left 38 and right 40 are directly affected by these left and right potential differences respectively. Moreover, positive left terminal 68 is linked directly at the same time to the positive of left secondary loudspeaker 42 and to the negative of right secondary loudspeaker 44 through a polarized capacitor 60, and vice versa for right positive terminal 72.

The negative terminals of the two secondary loudspeakers are also linked to ground, each through two polarized capacitors 64 and 66.

In the preferred application of the invention, the polarized capacitors are turned in the direction as shown by the figure; however, it is important to note that the invention will work irrespective of the direction in which the capacitors are turned, for instance when common ground 70 becomes positive, barrier 66 prevents its signal from going to left loudspeaker 42 but permits the signal to pass through capacitor 64 to loudspeaker 44 while being blocked by barrier 60. When common ground 70 is negative, terminals 72 and 68 are positive, the signal of terminal 68 is going to loudspeaker 42 and by passing capacitor 60, it is going to loudspeaker 44. During this time, terminal 72 which is also positive, cannot go to ground 70 because of capacitors 64 and 58.

In action, this circuit is characterized by instantaneous local potentials 48, 50, 52, 54, 56, each characterizing a location of the circuit. A location assigned as Left Primary Feed (abbreviated as PGA in French) 48 potential connected to loudspeaker 38, a Right Primary Feed (abbreviated as PDA in French) 50 potential connected to right primary loudspeaker 40, a Left Secondary Feed (abbreviated as SGA) 52 potential connected to left secondary loudspeaker 42, a Right Secondary Feed (abbreviated as SDA 54 potential connected to right secondary loudspeaker 44 and a primary ground 56 potential. In the embodiment of FIG. 2, the potentials are taken on the conducting materials at a representative location of the circuit, in relation to an existing potential, with conductor 52 being the continuation of conductor 48, except for the loss through terminal 68. The same is true for conductors 50 and 54. Primary loudspeakers 38, 40 are united in a common ground 56; secondary loudspeakers 42, 44 are united respectively on the positive side, to primary loudspeakers 38, 40 and to terminals 68, 72 that are united among themselves indirectly through blocking capacitors. For that purpose, a right left barrier 58 is positioned in parallel with right secondary loudspeaker 44 to reduce the signal to left secondary loudspeaker 42. A left right barrier 60 is positioned in parallel with left secondary loudspeaker 42 to reduce the signal to right secondary loudspeaker 44. After each of barriers 58 and 60, there are two other blocking capacitors 64, 66, this being a capacitor 64 that blocks 50% of the time the signals passing through loudspeaker 44 and which as such links 50% of the time the signals to common feed ground 70. The same process takes place for capacitor 66, though passing through loudspeaker 42 fed by capacitor 52. Barriers 58 and 60 are polarized capacitors for which the direction is similar one for the other, so as to, at a given moment, let the signals pass and at a second time, block these same signals. The same is true for capacitors 64 and 66. Polarized capacitors are used to block the primary signals at a given time. Explanation: when the signal from conduit 54 originating from a source, namely right positive feed 72, and going to right secondary loudspeaker 44 meets the way of blocking capacitor 58, the signal is momentarily blocked and it passes through loudspeaker element 44, after which it finds on its way two other barriers 60, 64. At that time, the signal is totally blocked. During this same time, the signal fed by primary left positive terminal 68 can pass through loudspeaker 42 and pass simultaneously through capacitor 60 towards loudspeaker 44. What passes through loudspeaker 42 is blocked by capacitor 66 but finds an open way through capacitor 58 and returns to conductor 54, of which it reduces or increases the potential from a value of “X” volts that loudspeaker 42 will play; the same process takes place for loudspeaker 44 but while passing through capacitor 60. As such, one achieves the elimination of the common sources and the passage of the different signals only. When the pulse or polarity changes phase, the process is reversed and negative 70 has become positive that feeds both loudspeakers 42, 44 passing through capacitors 66, 64.

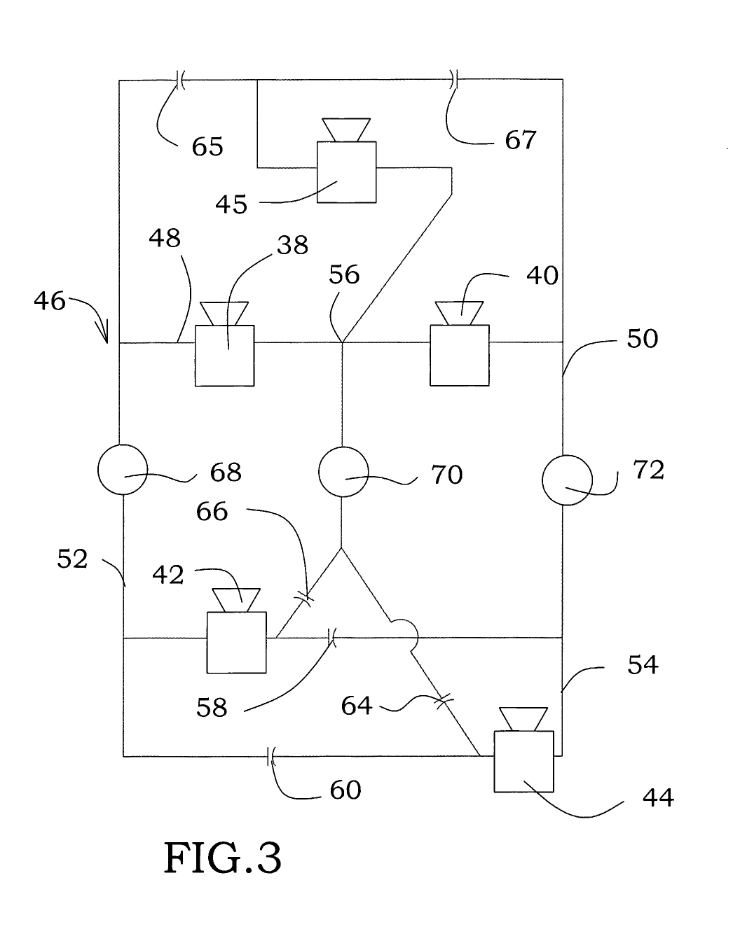

FIG. 3 illustrates an alternative embodiment of the invention. In this embodiment, an additional loudspeaker is added to the existing circuit. An additional conductor is positioned between the positive terminal of left signal 68 and the positive terminal of right signal 72. Two capacitors 65 and 67 are installed along this additional capacitor. Between the capacitors, along the additional capacitor, another conductor links the additional conductor to ground 70. The additional loudspeaker is positioned along this conductor with its positive terminal linked between capacitors 65 and 67, while the negative terminal is linked to ground 70. Capacitors 65, 67 can be turned in any direction but with the configuration illustrated, they act out of phase with the other capacitors which results in minimizing a drop in impedance of the circuit and thus avoiding the alteration of the stereophony of the primary signal. A judicious choice of the capacitance value of capacitors 65, 67 permits optimizing the system. The advantage of adding such an additional loudspeaker is the possibility of obtaining an additional channel appropriate for a central loudspeaker; the signal thus obtained corresponds to the common signals of the left and right primary signals, wherein the different component of the signals is eliminated. In general, such a loudspeaker is very well positioned between the two main enclosures.

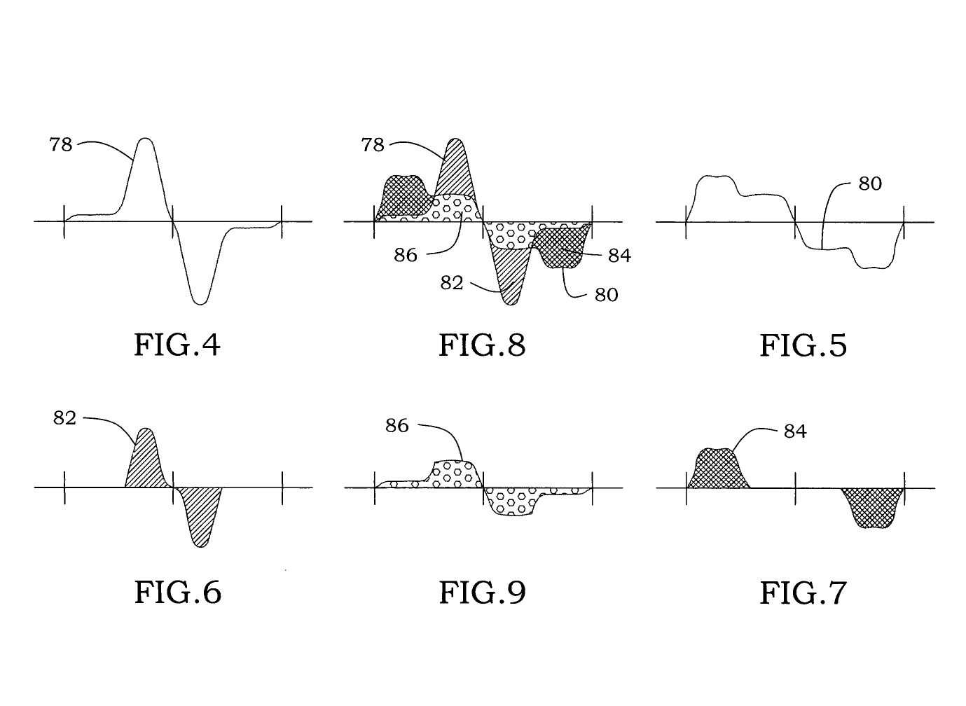

FIGS. 4 to 9 show an example that illustrates what takes place to the primary signals thanks to the device. First of all, we see an example of left and right primary signals in FIGS. 4 and 5 respectively. Each signal is shown as a variation in time of the amplitude of the electrical potential between the positive and negative terminal of each signal. The potential corresponding to the common ground is represented by the horizontal line of each figure. The potential increases when the considered point moves away from this horizontal line, to give a positive potential upward and a negative downward. Here, the passing of time is represented by the progression along the horizontal line. We see that all these signals are alternating: it produces a positive time, then a negative time.

We see that FIGS. 4 and 5 are different, which may correspond, for instance, to a left signal 78 FIG. 4 and a right signal 80 FIG. 5 of a stereo source. FIG. 8 shows a superposition of the two primary signals 78, 80 of FIGS. 4 and 5 so as to be able to analyze the various components of these signals; they have common components 86 and different components 82, 84.

FIGS. 6 and 7 represent secondary signals left 82 FIG. 6 and right 84 FIG. 7 obtained, respectively. As we had stated previously, action of the device permits the elimination of the common components of the stereo source. As such, we can see that FIGS. 6 and 7 represent the signals of FIGS. 4 and 5 respectively, wherein the components of common signal 86 FIG. 9 is subtracted or removed. Two new signals 82, 84 FIGS. 6 and 7, different from the other and the primary signals, are obtained.

FIG. 9 shows a signal that represents common component 86 to the two primary signals. This signal represents as such what must be removed from FIGS. 4 and 5 to obtain FIGS. 6 and 7 respectively. FIG. 9 shows a signal that might be reproduced by a front loudspeaker 45 and additional components to the circuit of FIG. 2. This signal can very well be used as tertiary signal for a central enclosure 45.

### DISCUSSION OF THE PREFERRED APPLICATIONS OF THE INVENTION

An objective of this invention is that the circuit includes ideally four loudspeakers, of which two the primary are in the front (FR and FL) and the two secondary which can be located either on the extreme right and left in the front, or in the rear (RR and RL). In the preferred application, the two primary loudspeakers play the unaltered stereo signals; while the two secondary loudspeakers play the new channels created by the electrical or electronic components used in the circuit. As such, the circuit is fed only by the unaltered stereo source and produces two new different channels from this one, giving a total of four different channels. The secondary loudspeakers produce a signal corresponding to the primary loudspeakers but with any common signal removed; the result for a listener is the perception of a new stereo modulation of the primary signals, thus giving the impression of an additional sound dimension. The electrical components used consist preferably of polarized capacitors, that let pass a sound section at a time, with an intensity proportional to the potential and frequency difference between the two primary signals, taking into account the amplitude and frequency of the signals. The polarized capacitors permit the elimination of the common signals of the primary signals in the two newly produced secondary signals. For elements 58 and 60, it is preferable to use high-value capacitors to eliminate as much as possible that which is common in both pass bands, while respecting a certain limit so as not to alter the primary signals.

The use of polarized capacitance with a very high capacitance value comes close to the extreme case where there are no capacitors at all and as such [there is] a short circuit. In contrast, the use of low capacitance capacitors comes close to the extreme case where there is no contact at all, and as such, no secondary signal. Consequently, one can easily imagine that a judicious choice of capacitors is essential for the optimal operation of the invention.

The advantages with respect to the prior art are the possibility of appreciating a new sound dimension with equipment that is inexpensive and easy to use; it can be directly installed on practically any stereo equipment. The two secondary loudspeakers can be installed at several locations which gives the system greater versatility.

It is our idea to use the difference of potential between the left and right signals as an indicator to send the signal to specific locations. We want that the left and right rear channels play when the signal is the strongest on the left or right side respectively, so that when the secondary loudspeakers are installed in the rear of each side respectively, if a train passes from left to right, one will have the impression that this train passes from the left rear to the left front, to the right front and then to the right rear thus creating the impression of a three-dimensional sound. We have selected a rectified wave with the positive part of the wave on one side and the negative part on the other. For that, we have used polarized capacitors and connected them to reverse their directions between positive terminals 68, 72 and negative terminal 70 of the primary signals.

In current use, the device will be able to be distributed in the form of a box comprised of two pairs of connectors, namely two signal inputs and two signal outputs. Inputs 68, 72 are fed by the same source that feeds the primary loudspeakers. Each output feeds one or several secondary loudspeakers respectively. Each output can feed one or several loudspeakers connected either in series or in parallel with respect to the output.

### Areas of Use

The invention is used in the passive mode as well as in the active mode. In the active mode, the channels are connected to the inputs of an amplifier rather than directly to loudspeakers.

Moreover, it is possible to use the invention in various applications such as: movies, shows, operas, cars, and others that use a standard or encoded stereo source.

### SUMMARY

A device that converts two left and right primary sound signals of a stereo input into four different signals; the four signals are identified as follows: one=front left 38, two=right front 40, three=rear left 42, four=rear right 44; the secondary signals are used to produce one or more sounds different from the primary sounds, with the device comprised of:
a pair of connections on the left 26 and on the right 28 of the primary loudspeakers 38, 40, left and right,
a pair of connections on the left 30 and on the right 32 at the secondary loudspeakers left 42 and right 44, with right connections 28, 32 linked to a positive side and left connections 26, 30 linked to a second positive side, with left and right primary loudspeakers 38, 40 linked together to a negative side by a floating common 56, with the secondary signals comprising barriers for the purpose of blocking respectively a part of a wave generated by the primary signals.

Signals one and two define the primary signals and signals three and four define the new and corresponding secondary signals with the new signals being non-zero when there is a positive or negative potential difference between the corresponding primary signals.

From a primary signal stereo source comprised of common parts, the device permits to generate a second stereophonic source different from the first, with the device comprising means for eliminating the common parts of the primary stereo source.

The device can function with an encoded primary sound source.

The device can be used in the passive mode, during which the primary sound signals are linked to loudspeakers. The devices can be used in the active mode during which the primary sound signals are linked to amplifiers and/or preamplifiers. The barriers include a parallel circuit connected to a conduit 50, 54 linking 40 to 44, the parallel circuit going to 42 and comprising in its center a DG barrier 58 and in the same way for a conduit 48, 52 comprised of a barrier 60, with the parallel circuit including also a link to ground comprised of a barrier 66 and a barrier 64, with barriers 58, 60 not being opposite one to the other and barriers 66 and 64 also not being opposite one to the other. Barrier 66 could be opposite to 64 to avoid having the impedance drop and permit blocking when Potential PM 56 is positive and permit passage when preferred circuit 46 is positive.

Barriers 58, 60, 66, 64 are polarized capacitors in the illustration: that has given the best results during the experiments. It is important to observe of course that other barriers can be used, such as diodes or transistors instead of capacitors, and that different and/or additional electrical and/or electronic devices can be used as an equivalent to the means and devices presently used. Consequently, it is important to understand that the means and devices used in the illustrations and the description of embodiments, represent only one of many ways to arrive at the ends expressed above consisting essentially in the creation of two additional channels having the potential of increasing stereophony by the fact that the common signals to the primary signals are eliminated. The same ends can be achieved by a different but equivalent circuit. The manner illustrated only shows one way that has proven to be simple and effective to arrive at the expected results.

It is well understood that the mode for executing this invention described above, in reference to the attached drawings, has been given for information purposes and is not limiting in nature, and that modifications and adaptations can be made without the object deviating from the scope of this invention. Other embodiments are possible and limited only by the scope of the claims that follow:

LEGEND
20-Common signal eliminator
22-Topside
24-Lateral side
26-Left primary output
28-Right primary output
30-Left secondary output
32-Right secondary output
34-Stereo source left input
36-Stereo source right input
38-Left primary loudspeaker
40-Right primary loudspeaker
42-Left secondary loudspeaker
44-Right secondary loudspeaker
45-Tertiary loudspeaker
46-Preferred circuit
48-PGA potential
50-PDA potential
52-SGA potential
54-SDA potential
56-PM potential
58-Capacitor 4
60-Capacitor 1
64-Capacitor 2
65-Capacitor 5
66-Capacitor 3
67-Capacitor 6
68-Left feed+
70-Common ground
72-Right feed+
74-Left secondary signal
76-Right secondary signal
78-Left primary signal
80-Right primary signal
82-Left secondary signal
84-Right secondary signal
86-Tertiary signal

1. A device that converts two primary sound signals, the left and right signals of a stereo source, into several different signals each comprising a positive terminal and a negative terminal, with four of these signals identified as follows: a first signal defined by a left primary signal (26), a second signal defined by a right primary signal (28), a third signal defined by a left secondary signal (30) and a fourth signal defined by a right secondary signal (32), with these secondary signals being different among each other and different from said primary signals; with said device comprising:
two inputs (34, 36), one left, connected to said left primary signal and a right one, connected to said right primary signal, with each input comprising a positive terminal and a negative terminal,
two outputs (30, 32), one left, connected to said left secondary signal and a right one, connected to said right secondary signal with each output comprising a positive terminal and a negative terminal, defining said secondary signals;
a first electrical conductor connecting said positive terminal of said left input to said positive terminal of said left output,
a second electrical conductor connecting said positive terminal of said right input to said positive terminal of said right output,
a third electrical conductor connecting said positive terminal of said left input to said negative terminal of said right output and comprising a first barrier,
a fourth electrical conductor connecting said positive terminal of said right input to said negative terminal of said left output and comprising a second barrier,
a fifth electrical conductor comprising a third barrier and connecting said negative terminal of said left output to said negative terminal of said left input, a sixth electrical conductor comprising a fourth barrier and connecting said negative terminal of said right output to said negative terminal of said right input, with said barrier producing a subtracting effect of the common components for said primary signal producing secondary signals where said common components are eliminated.

2. The device of claim 1 in which said first and second signals define primary signals and in which said third and fourth signals define new and respectively corresponding secondary signals, with one of said new signals being non-zero when there is a positive or negative potential difference between said primary signals.

3. A device that permits, from a pair of signals that define a first source of primary stereo sound comprising common parts, with said common parts comprising parameters such as frequencies, amplitudes, voltages for one and the other of said signals of said pair, with said device comprising parameter barriers aimed at eliminating said common parts from each of the signals of said pair of signals, thus generating a pair of signals that define a second secondary stereo source different from the first source of stereo sound; which permits increasing stereophony when the signals activate loudspeakers and when secondary loudspeakers are added to the primary ones.

4. The device of claim 3 in which the stereo sound source is an encoded source.

5. The device of claim 3 in which the stereo sound source is a non-encoded source.

6. The devices of claims 3 used in the post-amplification passive mode, in which said primary and secondary sound signals are linked to loudspeakers.

7. The devices of claims 3 used in passive mode in which said primary and secondary sound signals are linked to amplifiers and/or preamplifiers.

8. The devices of claims 3 used in a post-amplification active mode in which said primary and secondary sound signals are linked to loudspeakers.

9. The devices of claims 3 used in active mode, in which said primary and secondary sound signals are linked to amplifiers and/or preamplifiers.

10. The device of claim 1 comprising also a tertiary signal and:
a seventh electrical conductor comprising a fifth barrier and connecting said positive terminal of said left primary signal to said positive terminal of said tertiary signal,
an eighth electrical conductor comprising a sixth barrier and connecting said positive terminal of said right primary signal to said positive terminal of said tertiary signal,
a ninth electrical conductor linking said negative terminal of said tertiary signal to a negative terminal of a primary signal, with said barriers producing a tertiary signal that corresponds to said common component of said left and right primary signals.

11. The device of claim 1 in which said barriers are polarized capacitors, diodes, transistors and/or another directional barrier.

12. The devices of claim 6 in which said secondary sound signals are active.

13. The devices of claim 8 in which said secondary sound signals are passive.

14. A device that converts two primary signals, a left signal and a right signal of a stereo signal source, into two secondary signals different one from the other; with said secondary signals being identified as follows: a third signal that is defined by a left secondary signal (42), a fourth signal that is defined by a right secondary signal (44); with said secondary signals corresponding to said primary signals but where the common components of said primary signals have been eliminated; with each of said signal comprising a negative terminal and a positive terminal; with said device comprising:
a first electrical conducting means such as for instance a Secondary Left Feed potential (abbreviated as SGA in French) (52) linking said positive terminal of said left primary signal to said positive terminal of said left secondary signal,
a second electrical conducting means like a Secondary Right Feed (abbreviated as SDA in French) (54) potential linking said positive terminal of said right primary signal to said positive terminal of said right secondary signal,
a third electrical conducting means comprising a first polarized capacitor (60) and linking said positive terminal of said left primary signal to said negative terminal of said right secondary signal;
a fourth electrical conducting means comprising a second polarized capacitor (58) and linking said positive terminal of said right primary signal to said negative terminal of said left secondary signal,
a fifth electrical conducting means comprising a first polarized blocking capacitor (66) and linking said negative terminal of said left secondary signal to said negative terminal of said left primary signal,
a sixth electrical conducting means comprising a second polarized blocking capacitor (64) and linking said negative terminal of said secondary right signal to said negative terminal of said right primary signal; so that the potential difference between said positive terminals of the two primary signals affects the amplitude of the two secondary signals, with said device creating zero secondary signals when said potential difference is zero.

15. The device of claim 14 comprising also two secondary loudspeakers, one left and one right, and where said secondary left and right signals feed the two secondary left and right loudspeakers, respectively, by means of electrical conductors.

16. The device of claim 14 comprising also two primary loudspeakers, one left and one right, and where the primary left and right signals feed also the two primary left and right loudspeakers respectively, by means of electrical conductors.

17. The device of claim 14 comprising also a box, with said box including two inputs and two outputs, with each input or output comprising a positive terminal and a negative terminal; with said inputs of the box corresponding to the primary signals, with said outputs of said box corresponding to said secondary signals and with said conducting means located inside said box.

18. The device as claimed in claim 14 further converting said primary signals into a tertiary signal and also comprising a positive terminal and a negative terminal; said tertiary signal corresponding to the components common to said primary signals and where the other components have been eliminated; said device further comprising:
seventh electric conduction means comprising a polarized capacitor and connecting said positive terminal of said tertiary signal to said positive terminal of said primary left signal,
eighth electric conduction means comprising a polarized capacitor and connecting said positive terminal of said tertiary signal to said positive terminal of said primary right signal,
ninth electric conduction means connecting said negative terminal of said tertiary signal to said negative terminals of said primary signals, such that said difference in potential influences the amplitude of said tertiary signal, said device creating a tertiary signal identical to said primary signals when said difference in potential is zero.

19. The device as claimed in claim 18 further comprising a tertiary loudspeaker, and where said tertiary signal feeds said tertiary loudspeaker by means of electric conductors.

20. The device as claimed in claim 14 where one or more of said polarized capacitors are replaced by at least one diode, a transistor or other blocking directional electric means.

21. The device as claimed in claim 14, in which said first blocking capacitor (66) is opposite said second blocking capacitor (64) so as to avoid lowering the impedance allowing blockage when a primary earth potential (56) is positive and allowing passage when a preferred circuit (46) is positive.

22. A method for providing a three-dimensional stereo sound, the method comprising:
receiving a left primary signal of sound and a right primary signal of sound from a stereo source;
identifying a common part between said left primary signal and said right primary signal;
subtracting said common part from the left primary signal to create a left secondary signal;
subtracting said common part from the right secondary signal to create a right secondary signal; and
channeling said left secondary signal and said right secondary signal to respective outputs located so as to obtain said three-dimensional stereo sound.

23. The method of claim 22, comprising also the creation of a tertiary signal from said common part, and the transmission of said tertiary signal to a central enclosure.

24. The method of claim 22, wherein receiving a left primary signal and a right primary signal from a stereo source includes receiving signals from an encoded source.

25. The method of claim 22 wherein subtracting said common part from the left primary signal and subtracting said common part of the right primary signal includes the use of barriers to prevent said common part from continuing its way.

26. The method of claim 25, wherein the use of barriers includes the use of polarized capacitors.

27. The method of claim 25, wherein the use of barriers includes the use of diodes.

28. The method of claim 22, wherein channeling said left secondary signal and said right secondary signal includes channeling said left secondary signal to a rear left loudspeaker and channeling said right secondary signal to a rear right loudspeaker.
